(19) United States
(12) Patent Application Publication
(10) Pub. No.: US 2015/0108767 A1
(43) Pub. Date: Apr. 23, 2015

(54) CONSTANT VELOCITY DEVICE FOR DOWNHOLE POWER GENERATION

(71) Applicant: HALLIBURTON ENERGY SERVICES, INC, Houston, TX (US)

(72) Inventor: Daniel Martin Winslow, Spring, TX (US)

(73) Assignee: HALLIBURTON ENERGY SERVICES, INC., Houston, TX (US)

(21) Appl. No.: 14/371,343

(22) PCT Filed: Sep. 17, 2013
(86) PCT No.: PCT/US2013/060188

§ 371 Date: Dec. 19, 2014

(51) Int. Cl. E21B 4/00; F16D 3/16; H02K 7/18; E21B 3/00

(52) U.S. Cl. CPC E21B 4/006; E21B 3/00; F16D 3/16; H02K 7/1807
USPC 290/1 C; 464/163; 175/106

(57) ABSTRACT

A disclosed example embodiment of a constant velocity device positionable in a well bore includes a continuously-variable transmission, including an input race coupled to a rotational power input shaft, an output race, and a plurality of transmission elements disposed between the input race and the output race in a planetary formation. The transmission elements are configured to transmit rotational power from the input race to the output race. The constant velocity device also includes a weighted rotor assembly coupled at a first end to the output race. The weighted rotor assembly includes at least two weighted lever arms rotatable about a central axis of a power output shaft coupled to a second end of the weighted lever arms.

### TECHNICAL FIELD

This invention relates to a constant velocity device positionable in a well bore for downhole power generation.

### BACKGROUND

During well drilling operations, a drill string is lowered into the wellbore. On the distal end of the drill string may be located well logging tools and measurement while drilling (MWD) telemetry tools. Positioned below these tools proximal to a distal end of the drill string may be a drill bit.

The logging and/or telemetry tools often require electrical power. Supply and generation of electrical power downhole, however, can be problematic for a number of reasons. Additionally, storage of electrical energy in certain regions of the wellbore can be problematic due to high temperatures and other harsh conditions that are outside the operational limits of conventional batteries and capacitors. Performance of electric generators is maximized best when the generator is driven operated at a near constant rotational velocity. Alternatively other downhole drilling devices may be positioned in the drill string above the drill bit and it may be desirable for such tools to operate at near constant rotational velocity, such as steering tools, formation pressure evaluation tools, formation coring tools, or telemetry tools.

### DESCRIPTION OF DRAWINGS

FIG. 1 is a cross section of a section of a drill string including a constant velocity device in a downhole power section.

FIG. 2 is an enlarged partial cross section of a turbine in the drill string section of FIG. 1.

FIGS. 3A and 3B are enlarged partial cross sections of a portion of the constant velocity device of FIG. 1.

FIG. 4 is a flow chart showing a method of using the constant velocity device of FIG. 1.

FIG. 5 is a cross section of an alternate embodiment of the constant velocity device.

FIG. 6 is a flow chart showing a method of using the constant velocity device of FIG. 5.

Like reference symbols in the various drawings indicate like elements.

### DETAILED DESCRIPTION

Energy generated in a downhole power section can be used to drive a variety of downhole tool functions. Components of a tool string may be energized by mechanical (e.g., rotational) energy, electrical power, fluid (e.g., hydraulic) power, or other energy that can be converted from the rotation of a rotor in a downhole power section. In well bore drilling operations it is desirable that the power source be able to provide reliable power in the conditions of a downhole drilling environment (extreme temperatures, pressures, or other conditions). Although batteries provide one option, batteries have a limited lifespan and must be replaced or recharged, requiring tripping and disassembly of the drill string.

In some implementations a down hole drilling motor (e.g. a downhole turbine) may be positioned in the drill string. Drilling fluid (also referred to in the industry as drilling mud) flowing across the vanes in the turbine rotates an output shaft that may be used to drive a downhole generator. However, the rotation rate of such a turbine output shaft is often either too fast or too slow to directly drive a given downhole function, for example an electric generator or other down hole tool. By inserting a constant velocity device for regulating the speed between the output shaft and the function to be driven, the rate of rotation can be altered for the driven function, thereby improving overall performance of the function.

The output shaft may rotate at a rate that is substantially slower or higher than a desired rotation rate for a tool component to be driven. For example, the output shaft 45 may rotate at 120 revolutions per minute or RPM, while a desired rotation rate of an electric generator 190 may be at a generally higher speed. In this case the constant velocity device would require gearing adapted to provide increased rotational speed to the generator 190 relative to the output shaft 45 rotation rate.

In addition to having a rotational speed not ideal for electrical power generation, in a typical drilling operation the downhole mud or drilling fluid impinging the turbine may have varying flow rates (velocity) in the drill string. Variation in flow rate speed causes variation in the rotational speed of the turbine. As electric generators generally require constant input speed it is desirable to normalize the output speed of the turbine 110 due to the varying downhole mud speed such that the electric generator 190 receives a relatively constant input speed. The constant velocity device of this disclosure provides this function.

In other implementations, the relative motion between one portion of the drill string and another may provide a source of rotational power to drive a downhole generator. For example, in a rotary steerable drilling system, the rotary motion of the bit, relative to the fixed housing for the steerable tool may be used with a constant velocity device (e.g., a continuously variable transmission) to keep the relative motion constant and likewise the mechanical power applied to the generator. A power distribution system such as a planetary gear system can be used to generate power from the relative motion. A constant velocity device, such as a continuously variable transmission (“CVT”) or slip clutch is used to maintain a relatively constant power output.

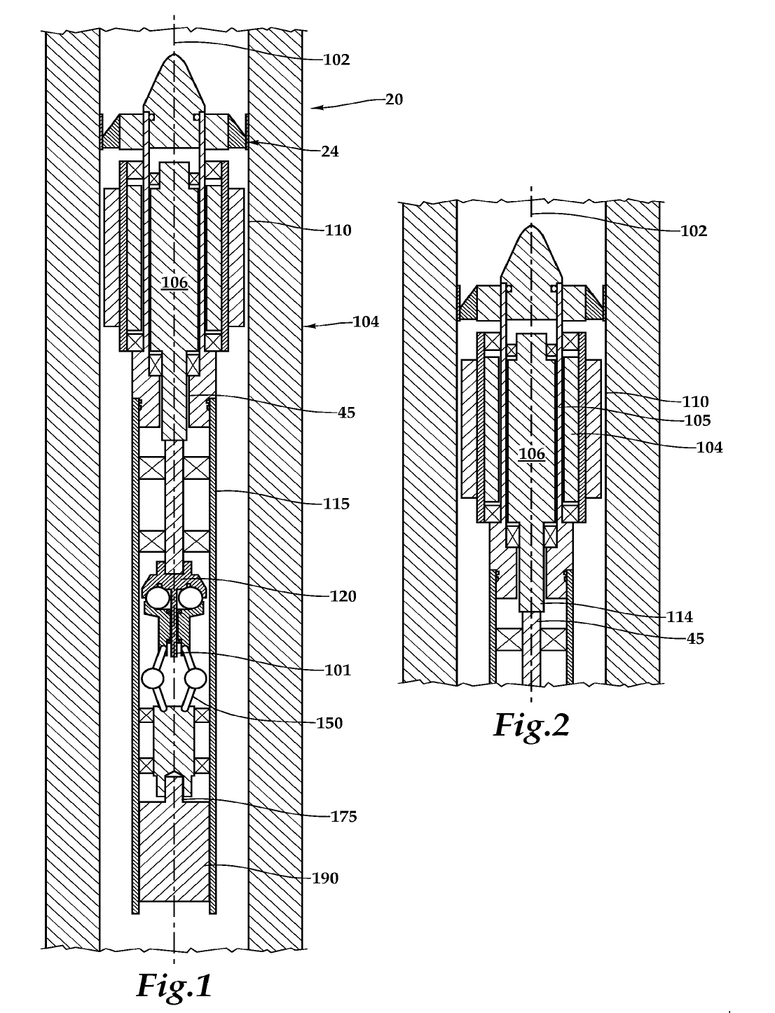

As shown in FIG. 1, a downhole section 100 has a downhole mud powered turbine 110 which converts fluid flow into rotational energy. The turbine 110 outputs this rotational energy to constant velocity device 101 that includes a continuously variable transmission (CVT) 120 which is connected to a levered rotor 150 whose output drives an electric generator 190 which converts the rotational energy to electrical energy. The rotatable elements of these various components rotate at least around a central axis of rotation 102. The various components of the constant velocity device 101 of this disclosure are contained within a drill string 20, within a portion of the drill collar 104. A stator 24 and the turbine 110 generally have a cross sectional area that fills the bore of the drill string 20, whereas other components (i.e., the CVT 120, a levered rotor 150 and a generator 190) may be smaller than the cross sectional area of the drill string 20. The CVT 120, levered rotor 150 and generator 190 and their related components are contained within a generator housing 115 that is generally filled with oil or other lubricant to lubricate the various components. The fluid or mud travelling through the turbine 100 flows out of the turbine and then through an annular space between the generator housing 115 and the drill collar 104.

A transmission 120, such as a continuously variable transmission 120, may be installed between the turbine 110 and the levered rotor 150. A CVT 120 may be used together with the levered rotor 150 to produce a desired output speed by adjusting the gear ratio between the turbine 110 and the generator 190. This may reduce the possibility that the turbine 110 or generator 190 are damaged by rapid or sudden movement of one of the components and may reduce the torque or stress at any point between the two. The CVT 120 enables the levered rotor 150 to smoothly and efficiently accelerate to a desired speed while allowing the generator 190 to rotate at a more uniform and constant speed. This also allows the generator 190 to rotate at a speed corresponding to its peak efficiency.

Referring to FIG. 2, the turbine 110 may have a magnetic coupled drive shaft 103. The magnetic coupled drive shaft 103 includes an outer magnet carrier 104 and a turbine shaft 105 with an inner magnet carrier 106. Use of a magnetic coupled drive shaft 103 is particularly advantageous as the drilling fluid may be abrasive and contain sand particles and the magnetic drive shaft eliminates the need for protective rotary seals.

In some embodiments, a magnetic coupling 114 may be used between the turbine 110 and the CVT 120. This magnetic coupling 114 may include, for example, various magnets along the turbine shaft 105 that interact with magnets placed on output shaft 45 coupled to the CVT 120. Power may be transmitted between the shafts 105, 45 by the magnetic forces acting between the magnets. A non-magnetic barrier is placed between the two magnetic couples to allow the drilling fluid to be separated from lubricating oil.

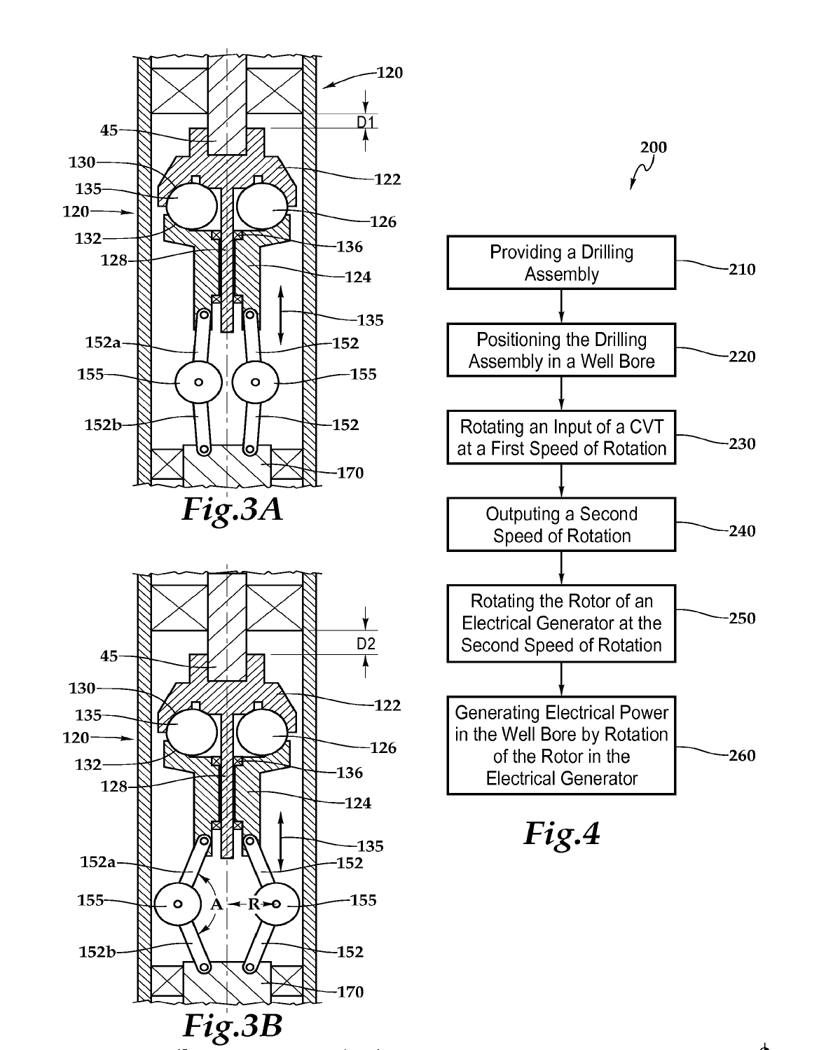

The CVT 120 and the levered rotor 150 function together to regulate the speed that is input to the attached generator 190 and receives the output motion from the levered rotor 150. The continuously variable transmission 120 is a roller-based CVT that is based on a set of rotating, translating balls fitted between two races. As shown in FIG. 3A, the CVT 120 includes an input race or ring 122, driven by the output shaft 45 of the turbine 110, an output race 124 connected to the levered rotor 150, and a set of transmission balls 126 each rotating on its own axle and fitted between the input race 122, the output race 124 and a central spoke 128 that helps maintain the balls in position. The CVT 120 also has a preloaded spring 136 with properties chosen to set the initial state of the CVT 120 to be a chosen speed, e.g., 1000 RPM, which results in the CVT producing a 1:1 gear ratio. The spring 136 acts as a balancing force that the force produced by levered rotor 150 must work against so that the CVT is at the target position at the target speed

Rotational energy from the turbine 110 is transferred through the input race 122 to the transmission balls 126 by frictional forces, which may be enhanced with using a thin layer of traction fluid 130. The rotational energy is then transmitted through the transmission balls 126 to the output race 124, which is some embodiments is enhanced by fluid 132. In embodiments in which torque is transmitted through the traction fluid 130, 132, destructive metal to metal contact between the transmission balls 126 and races 122, 124 is prevented while providing traction for the balls and rings and lubrication for bearings and other components.

The gear ratio, or the rotational speed of the input race 122 compared to the rotational speed of out race 124 is controlled by the relationship of the transmission balls 126 relative to the output race 124. FIG. 3B illustrates that shifting the location of the output race 124 on the transmission balls 126 can shift the gear ratio from low to high or from high to low, at any continuous gear ratio between the minimum and the maximum gear ratios possible for the particular CVT 120. For example, shown in FIG. 3A, the output race is close to the equator of the transmission balls 126. In this case the gear ratio is different from in FIG. 3B where the output race is closer to the pole, i.e., farther from the equator of the transmission ball 126. The number of transmission balls 126 used depends on several factors including torque and speed requirements, operational requirements and space considerations and can be between, for example, 3 and 6 balls.

The gear ratio of the CVT 120 can be changed by motion of a weighted rotor 150 assembly; the weighted rotor assembly includes lever arms 152 and weighted balls 155. As shown in FIGS. 3A and 3B, lever arms 152 are movably attached at a first end to the output race 124 of the CVT 120. Each lever arm is made of two portions, a first portion 152A connecting to the CVT 120, and a second portion 152B movably connected to an axially fixed coupling 170. The connection between the two portions 152A and 152B of the lever arms 152 is also movable, and is also movably connected to a weighted ball 155. The weighted balls 155 have a specific gravity high enough that when the weighted rotor assembly is rotated it has a moment of inertia large enough to overcome restorative forces tending to keep the weighted balls 155 in their initial positions. The weighted balls may be formed of lead and/ or other high density material. The lever arms and attached weighted balls 155 rotate around the central axis of rotation 102, as does the turbine 110 and the axially fixed output coupling 170.

Due to centrifugal force, as their rotational speed increases the weighted balls 155 tend to increase their distance R from the center axis of rotation 102. The rotational couplings between lever arm 152A, 152B, the axially fixed output coupling 170, and the CVT 120 are such that the lever arms 152A and 152B can change their angle A (with respect to each other), which permits the weighted balls 155 to increase or decrease their distance from the center axis of rotation 102 depending upon the rotational speed. Since the lever arms 152 have finite length and the most downhole end of lever arm 152B is axially fixed due to being connected to the axially fixed output coupling 170, the only degree of motion available is of the first lever arm 152A, which translates the output race 124 of the CVT along the direction shown by arrow 135. Increasing and decreasing the rotational speed (equivalent to changing the radial distance R, and the angle A) has the effect of translating the output race 124 of the CVT as shown by arrow 135, changing the gear ratio. This change in the gear ratio results in a change in the output velocity, i.e., the rotational speed transferred to the weighted balls 155, automatically adjusting the rotational speed of the weighted balls. For example, as the turbine velocity goes up, the weighted balls 155 get further apart, causing the gear ratio to drop. This provides a constant input rotational speed to the generator 190, and compensates for the varying input velocity of the drilling mud.

This final speed output from the constant velocity device 101 is transmitted rotationally via the axially fixed output coupling 170 to the input shaft 175 of the generator 190. The downhole generator 190 may be a conventional downhole rotational generator as used in the drilling industry.

As shown in FIG. 4, a method 200 of generating electrical power using the constant velocity device 101 in a well bore can include providing (step 210) a drilling assembly including a rotational power source, a continuously variable transmission 120 coupled to the rotational power source, and a weighted levered rotor 150 assembly coupled at a first end to the continuously variable transmission and coupled at a second end to a rotor of an electrical generator, as described above. The drilling assembly is positioned (step 220) in the well bore, and then flowing fluid provides an input motion and rotates (step 230) an input to the continuously variable transmission 120 at a first speed of rotation. The constant velocity device 101 outputs (step 240) a speed of rotation of an output of the weighted rotor assembly at a second speed of rotation which can be different than the first speed of rotation, which rotates (step 250) the rotor of the electrical generator at the second speed of rotation, generating (step 260) electrical power in the well bore by rotation of the rotor in the electrical generator.

An advantage of the constant velocity device 101 is that it compensates for varying drilling fluid input velocity and delivers a constant rotational speed to drive a downhole generator. This modulation in speed allows the generator 190 to rotate at a speed corresponding to its peak efficiency. The constant velocity device 101 also permits the system to avoid undesirable surges in voltage due to sudden increased speed of the generator input. For example, if the downhole flow rate changes enough to cause the turbine to increase speed there would be a commensurate change in generator voltage. There are limits on the amount of voltage that power conditioning circuits used in the drilling industry can accommodate. The constant velocity device allows for more reliable circuit design by allowing for circuits that can tolerate a lower voltage range.

An advantage of using the constant velocity device 101 to generate energy downhole is that the constant velocity device 101 is not as affected by high downhole temperatures as are batteries. Consequently, the constant velocity device 101 has a longer service life than batteries. A number of embodiments of the invention have been described. Nevertheless, it will be understood that various modifications may be made without departing from the spirit and scope of the invention. For example, although the CVT 120 is described above as being attached to a turbine, the CVT 120 could alternatively be attached to a positive displacement motor, a progressive cavity motor (mud motor), a vane motor or an impeller.

In some embodiments, as shown in FIG. 5, as an alternative to the levered rotor 150, active feedback system 270 can be used to change the gear ratio of the CVT 120. The active feedback system 270 includes a speed measurement device 272 such as is known in the art, which measures the speed of output race 124 of the CVT 120. To move the CVT 120 back and forth to change the gear ratio, for example, a small electric motor 274 may be attached to the generator housing 115. A controller receives the speed of the output race 124 of the CVT 120 and compares the speed to an optimal speed stored in the controller. If a discrepancy exists between the actual speed and optimal speed, the controller signals the electric motor 274 to drive a power screw 278 attached to the CVT 120 output race 124 to adjust the position of the power screw 278 and of the output race 124. Adjustment of the power screw 278 varies the gear ratio of the CVT 120, as described above. To accommodate this axial motion, the downhole end of the power screw 278 includes an axially adjustable connection to the generator 190. In some embodiments, the power screw would only be used to move the CVT output race 124 back and forth but not be used to transmit the rotation to the generator.

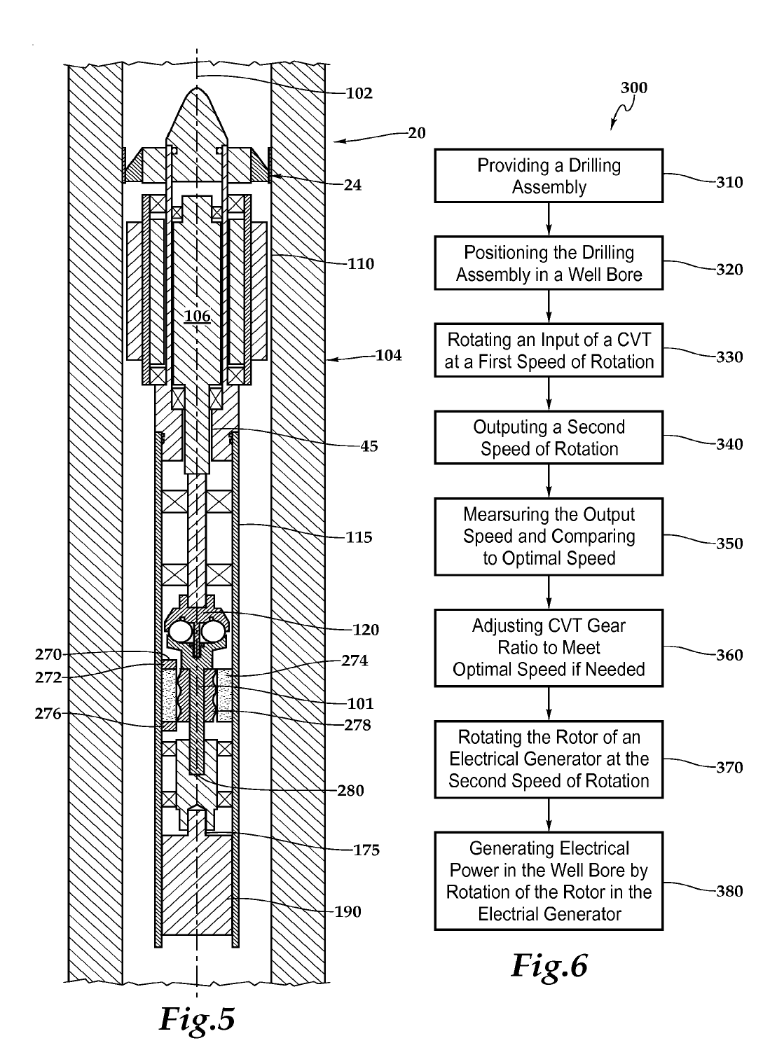

As shown in FIG. 6, a method 300 of generating electrical power using the constant velocity device 101 shown in FIG. 5 in a well bore can include providing (step 310) a drilling assembly including a rotational power source, a continuously variable transmission 120 coupled to the rotational power source, and an active feedback system 270 coupled at a first end to the continuously variable transmission and coupled at a second end to a rotor of an electrical generator, as described above. The drilling assembly is positioned (step 320) in the well bore, and then flowing fluid provides an input motion and rotates (step 330) an input to the continuously variable transmission 120 at a first speed of rotation. The constant velocity device 101 outputs (step 340) a speed of rotation of an output of the weighted rotor assembly at a second speed of rotation which can be different than the first speed of rotation. The controller 276 (via the speed measurement device 272) measures this output speed and compares it to an optimal speed for power generation (step 350). The controller than adjust the CVT 120 gear ratio as needed (step 360) which results in rotating (step 370) the rotor of the electrical generator at the second speed of rotation, generating (step 380) electrical power in the well bore by rotation of the rotor in the electrical generator.

Accordingly, other embodiments are within the scope of the following claims.

1. A constant velocity device positionable in a well bore, comprising:
a continuously variable transmission including:
an input race coupled to a rotational power input shaft;
an output race;
a plurality of transmission elements disposed between the input race and the output race in a planetary formation, said transmission elements configured to transmit rotational power from the input race to the output race; and
a weighted rotor assembly coupled at a first end to the output race, said weighted rotor assembly including at least two weighted lever arms rotatable about a central axis of a power output shaft coupled to a second end of the weighted lever arms.

2. The constant velocity device of claim 1, wherein rotation of the weighted rotor assembly changes a gear ratio of the continuously variable transmission.

3. The constant velocity device of claim 1, further comprising an electric generator coupled to the power output shaft of the weighted rotor assembly.

4. The constant velocity device of claim 1, wherein an angle between the weighted lever arms and the central axis is adjustable.

5. The constant velocity device of claim 1 wherein an angle between an upper weighted lever arm and a lower weighted lever arm is variable.

6. The constant velocity device of claim 5, wherein a distance between an intersection point of the upper weighted lever arm and the lower weighted lever arm to the central axis is variable.

7. The constant velocity device of claim 1, wherein the weighted lever arms produces a moment of inertia, wherein the moment of inertia of the weighted rotor assembly when rotating is greater than the moment of inertia of the output race of the continuously variable transmission when the output race is rotating a same speed as the weighted rotor assembly.

8. The constant velocity device of claim 3, wherein the second end of each of the weighted lever arms coupled to the power output shaft is fixed axially with respect to the electric generator.

9. The constant velocity device of claim 3, wherein the first end of each of the weighted lever arms coupled to the output race is variable axially with respect to the electric generator.

10. A downhole tool string, comprising:
a downhole drilling motor having a rotational output;
a continuously variable transmission having an attachment structure to connect to the rotational output of a turbine, said continuously variable transmission including: an input race coupled to a rotational power input shaft;
an output race;
a plurality of transmission elements disposed between the input race and the output race in a planetary formation, said transmission elements configured to transmit rotational power from the input race to the output race; and
a weighted rotor assembly coupled at a first end to the output race, said weighted rotor assembly including at least two weighted lever arms rotatable about a central axis of a power output shaft coupled to a second end of the weighted lever arms.

11. A method of generating electrical power in a well bore comprising:
providing a drilling assembly including:
a rotational power source,
a continuously variable transmission coupled to the rotational power source,
and
a rotor assembly coupled at a first end to the continuously variable transmission and coupled at a second end to a rotor of an electrical generator;
positioning the drilling assembly in the well bore;
rotating an input to the continuously variable transmission at a first speed of rotation;
outputting a speed of rotation of an output of the rotor assembly at a second speed of rotation different than the first speed of rotation;
rotating the rotor of the electrical generator at the second speed of rotation; and
generating electrical power in the well bore by rotation of the rotor in the electrical generator.

12. The method of claim 11, wherein providing a rotational power source comprises providing a down hole drilling motor.

13. The method of claim 11, wherein providing a continuously variable transmission comprises providing a continuously variable transmission including:
an input race coupled to a rotational power input shaft;
an output race; and
a plurality of transmission elements disposed between the input race and the output race in a planetary formation, said transmission elements configured to transmit rotational power from the input race to the output race

14. The method of claim 13, wherein providing a rotor assembly comprises providing a weighted rotor assembly coupled at a first end to the output race, said weighted rotor assembly including at least two weighted lever arms rotatable about a central axis of a power output shaft coupled to a second end of the weighted lever arms.

15. The method of claim 14 including:
rotating the weighted rotor assembly and generating a moment of inertia for the rotating weighted rotor assembly; and
rotating the rotor of the electrical generator at a same speed as a speed of rotation of the weighted rotor assembly and generating a smaller moment of inertia of the rotating rotor of the electrical generator.

16. The method of claim 14 including:
rotating the weighted rotor assembly and generating a moment of inertia for the rotating weighted rotor assembly; and
rotating an output race of the continuously variable transmission at a same speed as a speed of rotation of the weighted rotor assembly and generating a smaller moment of inertia of the rotating output race of the continuously variable transmission.

17. The method of claim 13, wherein providing a rotor assembly comprises providing:
a speed measurement device coupled to the output race of the continuously variable transmission; and
a motor with a controller operatively connected to an output of the speed measurement device, said motor having a rotary output shaft coupled to a power screw.

18. The method of claim 17, wherein outputting a speed of rotation of an output of the rotor assembly at a second speed of rotation different than the first speed of rotation includes:
measuring the second speed of rotation of the rotor assembly;
comparing the second speed to an optimal speed;
adjusting an axial position of the power screw; and
adjusting an axial position of the output race relative to the input race.

19. (canceled)
